(19) United States
(12) Patent Application Publication
(10) Pub. No.: US 2006/0022903 A1
(43) Pub. Date: Feb. 2, 2006

(54) Plasma display apparatus and driving method thereof

(76) Inventor: Seong Hak Moon, Seoul (KR)

Correspondence Address: MCKENNA LONG & ALDRIDGE LLP;Song K. Jung, 1900 K Street, N.W., Washington, DC, 20006, US

(21) Appl. No.: 11/188,662

(22) Filed: Jul. 26, 2005

(30) Foreign Application Priority Data
Jul. 27, 2004 (KR) 10-2004-0058925

(51) Int. Cl. G09G 3/28

(52) U.S. Cl. 345/60

(57) ABSTRACT

Provided are an apparatus and method for driving a plasma display panel, which are capable of increasing the brightness of the plasma display panel and minimizing power consumption and the amount of heat generation without increasing the number of sustain pulses. The plasma display apparatus includes: a plasma display panel including a scan electrode and a sustain electrode; a scan electrode driver for applying a first sustain pulse to the scan electrode; a sustain electrode driver applying a second sustain pulse to the sustain electrode alternately with the first sustain pulse; and a peak pulse applying unit causing a peak pulse to overlap the first sustain pulse and the second sustain pulse when the first sustain pulse and the second sustain pulse are alternately applied to the scan electrode and the sustain electrode.

This Nonprovisional application claims priority under 35 U.S.C. § 119(a) on Patent Application No. 2004-0058925 filed in Korea on 27 Jul., 2004, the entire contents of which are hereby incorporated by reference.

### BACKGROUND OF THE INVENTION

1. Field of the Invention

The present invention relates to an apparatus and method for driving a plasma display panel, and more particularly, to an apparatus and method for driving a plasma display panel using a peak pulse.

2. Description of the Background Art

FIG. 1 shows driving waveforms for use in a conventional plasma display panel. Referring to FIG. 1, the conventional plasma display panel is driven according to a reset period (that is, initialization period) for initializing the entire screen, an address period for selecting cells, and a sustain period for maintaining the discharge of the selected cells.

In the initialization period, during a set-up period SU, a rising ramp pulse Ramp-up is applied simultaneously to all scan electrodes Y. Thus, a dark discharge (that is, a set-up discharge) occurs in cells of the entire screen by the rising ramp pulse Ramp-up. Due to the set-up discharge, positive wall charges are accumulated on address electrodes X and sustain electrodes Z and negative wall charges are accumulated on the scan electrodes Y.

During a set-down period SD, a falling ramp pulse Ramp-down is applied. The falling ramp pulse Ramp-down falls from a positive voltage lower than the peak voltage of the rising ramp pulse Ramp-up to a ground voltage GND or a specific negative voltage, thus partially erasing wall charges excessively formed in the cells. Specifically, by applying the falling ramp pulse Ramp-down, the amount of wall charges which is sufficient to stably cause an address discharge remain uniform in the cells.

In the address period, a scan pulse Scan is applied sequentially to the scan electrodes Y and the sustain electrodes Z, and simultaneously data pulse data is applied to the address electrodes X in synchronization with the scan pulse Scan.

A voltage difference between the scan pulse Scan and the data pulse data is added with a wall voltage created during the initialization period, thereby causing an address discharge in cells to which the data pulse data is applied. In the cells selected by the address discharge, the amount of wall charges which is sufficient to cause a discharge when a sustain voltage is applied is formed.

At this time, a bias voltage Z_{dc} is applied to the sustain electrodes Z during the set-down period SD and the address period so as to reduce a voltage difference between the sustain electrodes Z and the scan electrodes Y and thus prevent a wrong discharge from occurring between the sustain electrodes Z and the scan electrodes Y.

In the sustain period, a sustain pulse Sus is applied alternately to the scan electrodes Y and the sustain electrodes Z. In the cells selected by the address discharge, a wall voltage in the cells is added with the sustain pulse Sus and accordingly a sustain discharge, that is, a display discharge occurs between the scan electrodes Y and the sustain electrodes Z whenever the sustain pulse Sus is applied.

After the sustain discharge is complete, a ramp waveform Ramp-ers having a narrow pulse width and a low voltage is supplied to the sustain electrodes Z, thereby erasing wall charges which remain in the cells of the entire screen.

In order to enhance the brightness of the plasma display panel using the above-described driving waveforms, it is needed to increase the number of sustain pulses Sus which are applied to the scan electrodes Y and the sustain electrodes Z during the sustain period.

However, increasing the number of sustain pulses Sus to enhance brightness results in increasing power consumption and the amount of heat generation in the plasma display panel and its driving circuit. These problems deteriorate the reliability of the plasma display panel and cause afterimages. Further, the problems increase loads on consumption power and driving devices, resulting in adverse effects on the reliability and operation of the plasma display panel.

### SUMMARY OF THE INVENTION

Accordingly, an object of the present invention is to solve at least the problems and disadvantages of the background art.

The present invention provides a plasma display apparatus which is capable of enhancing the brightness of a plasma display panel without increasing the number of sustain pulses.

The present invention also provides a plasma display apparatus which is capable of minimizing power consumption and the amount of heat generation.

According to an aspect of the present invention, there is provided a plasma display apparatus including: a plasma display panel including a scan electrode and a sustain electrode; a scan electrode driver applying a first sustain pulse to the scan electrode; a sustain electrode driver applying a second sustain pulse to the sustain electrode alternately with the first sustain pulse; and a peak pulse applying unit causing a peak pulse to overlap the first sustain pulse and the second sustain pulse when the first sustain pulse and the second sustain pulse are alternately applied to the scan electrode and the sustain electrode.

According to another aspect of the present invention, there is provided a plasma display apparatus including: a plasma display panel including a scan electrode and a sustain electrode; a scan electrode driver applying a first sustain pulse to the scan electrode; a sustain electrode driver applying a second sustain pulse to the sustain electrode alternately with the first sustain pulse; and a peak pulse generator causing a peak pulse to overlap sustain pulses when the sustain pulses are respectively applied to the scan electrode and the sustain electrode, wherein the peak pulse generator includes: a first peak pulse generator outputting a peak pulse to overlap a sustain pulse applied to the scan electrode; a first coupling circuit unit causing the peak pulse output from the first peak pulse generator to overlap the sustain pulse applied to the scan electrode; a second peak pulse generator outputting a peak pulse to overlap a sustain pulse applied to the sustain electrode; and a second coupling circuit unit causing the peak pulse output from the second peak pulse generator to overlap the sustain pulse applied to the sustain electrode.

According to another aspect of the present invention, there is provided a driving method of a plasma display apparatus, including: causing a first peak pulse to overlap a first sustain pulse when the first sustain pulse is applied to a scan electrode; and causing a second peak pulse to overlap a second sustain pulse when the second sustain pulse is applied to a sustain electrode.

Therefore, a plasma display apparatus and a driving method thereof, according to the present invention, have advantages of enhancing brightness and contrast, minimizing power consumption and the amount of heat generation, and ensuring the reliability and stable operation of the plasma display apparatus, by causing a peak pulse to overlap a sustain pulse without increasing the number of sustain pulses.

According to an aspect of the present invention, there is provided a plasma display apparatus including: a plasma display panel including a scan electrode and a sustain electrode; a scan electrode driver applying a first sustain pulse to the scan electrode; a sustain electrode driver applying a second sustain pulse to the sustain electrode alternately with the first sustain pulse; and a peak pulse applying unit causing a peak pulse to overlap the first sustain pulse and the second sustain pulse when the first sustain pulse and the second sustain pulse are alternately applied to the scan electrode and the sustain electrode.

The peak pulse applying unit causes the peak pulse to overlap the first sustain pulse and the second sustain pulse when sustain voltages respectively forming the first sustain pulse and the second sustain pulse are respectively applied to the scan electrode and the sustain electrode.

The peak pulse applying unit converts an input rectangular wave into the peak pulse, the peak pulse having a trigger pulse waveform, and causes the peak pulse to overlap the first sustain pulse and the second sustain pulse.

The scan electrode driver includes a first energy recovery circuit and the peak pulse applying unit causes the peak pulse to overlap the first sustain pulse when a sustain voltage forming the first sustain pulse is applied after energy is supplied by the first energy recovery circuit.

The sustain electrode driver includes a second energy recovery circuit, and the peak pulse applying unit causes the peak pulse to overlap the second sustain pulse when a sustain voltage constituting the second sustain pulse is applied after energy is supplied by the second energy recovery circuit.

The peak pulse applying unit includes: a first peak pulse generator outputting a peak pulse to overlap the first sustain pulse; a first coupling circuit unit causing the peak pulse output from the first peak pulse generator to overlap the first sustain pulse; a second peak pulse generator outputting a peak pulse to overlap the second sustain pulse; and a second coupling circuit unit causing the peak pulse output from the second peak pulse generator to overlap the second sustain pulse.

The first peak pulse generator includes a differential circuit and converts a rectangular waveform received through the differential circuit into a positive peak pulse and a negative peak pulse, each having trigger pulse waveforms, and the first coupling circuit unit causes the positive peak pulse to overlap the first sustain pulse.

The second peak pulse generator includes a differential circuit and converts a rectangular waveform received through the differential circuit into a positive peak pulse and a negative peak pulse, each having trigger pulse waveforms, and the second coupling circuit unit causes the positive peak pulse to overlap the second sustain pulse.

The first peak pulse generator generates the positive peak pulse of the trigger pulse waveform when the rectangular waveform rises and generates the negative peak pulse when the rectangular waveform falls.

The second peak pulse generator generates the positive peak pulse of the trigger pulse waveform when the rectangular waveform rises and generates the negative peak pulse when the rectangular waveform falls.

The first coupling circuit unit includes a first diode having an anode terminal connected to the first peak pulse generator, and a first capacitor having one end connected to a cathode terminal of the first diode and the other end connected to the scan electrode.

The second coupling circuit unit includes a second diode having an anode terminal connected to the second peak pulse generator, and a second capacitor having one end connected to a cathode terminal of the second diode and the other end connected to the sustain electrode.

The scan electrode driver includes a first energy recovery circuit, and the peak pulse applying unit causes the peak pulse to overlap the first sustain pulse when a sustain voltage constituting the first sustain pulse is applied after energy is supplied by the first energy recovery circuit.

The sustain electrode driver includes a second energy recovery circuit, and the peak pulse applying unit causes the peak pulse to overlap the second sustain pulse when a sustain voltage constituting the second sustain pulse is applied after energy is supplied by the second energy recovery circuit.

According to another aspect of the present invention, there is provided a plasma display apparatus including: a plasma display panel including a scan electrode and a sustain electrode; a scan electrode driver applying a first sustain pulse to the scan electrode; a sustain electrode driver applying a second sustain pulse to the sustain electrode alternately with the first sustain pulse; and a peak pulse generator causing a peak pulse to overlap sustain pulses when the sustain pulses are respectively applied to the scan electrode and the sustain electrode, wherein the peak pulse generator includes: a first peak pulse generator outputting a peak pulse to overlap a sustain pulse applied to the scan electrode; a first coupling circuit unit causing the peak pulse output from the first peak pulse generator to overlap the sustain pulse applied to the scan electrode; a second peak pulse generator outputting a peak pulse to overlap a sustain pulse applied to the sustain electrode; and a second coupling circuit unit causing the peak pulse output from the second peak pulse generator to overlap the sustain pulse applied to the sustain electrode.

According to another aspect of the present invention, there is provided a driving method of a plasma display apparatus, including: causing a first peak pulse to overlap a first sustain pulse when the first sustain pulse is applied to a scan electrode; and causing a second peak pulse to overlap a second sustain pulse when the second sustain pulse is applied to the sustain electrode.

The first peak pulse overlaps the first sustain pulse when a sustain voltage constituting the first sustain pulse is applied to the scan electrode.

The second peak pulse overlaps the second sustain pulse when a sustain voltage constituting the second sustain pulse is applied to the sustain electrode.

The first peak pulse overlaps the first sustain pulse when a sustain voltage is applied after energy for forming the first sustain pulse is supplied to a plasma display panel.

The second peak pulse overlaps the second sustain pulse when a sustain voltage is applied after energy for forming the second sustain pulse is supplied to a plasma display panel.

### BRIEF DESCRIPTION OF THE DRAWINGS

The invention will be described in detail with reference to the following drawings in which like numerals refer to like elements.

FIG. 1 shows driving waveforms for used in a conventional plasma display panel.

FIG. 2 is a block diagram of a plasma display apparatus according to the present invention.

FIG. 3 shows a circuit configuration composed of a first peak pulse generator, a second peak pulse generator, a first coupling circuit unit, a second coupling circuit unit, and electrode drivers, which is included in the plasma display apparatus according to the present invention, according to a first embodiment of the present invention.

FIG. 4 is a first embodiment of a sustain pulse waveform according to the present invention.

FIG. 5 shows a circuit configuration composed of a first peak pulse generator, a second peak pulse generator, a first coupling circuit unit, a second coupling circuit unit, and electrode drivers, which is included in the plasma display apparatus according to the present invention, according to a second embodiment of the present invention.

FIG. 6 is a second embodiment of a sustain pulse waveform according to the present invention.

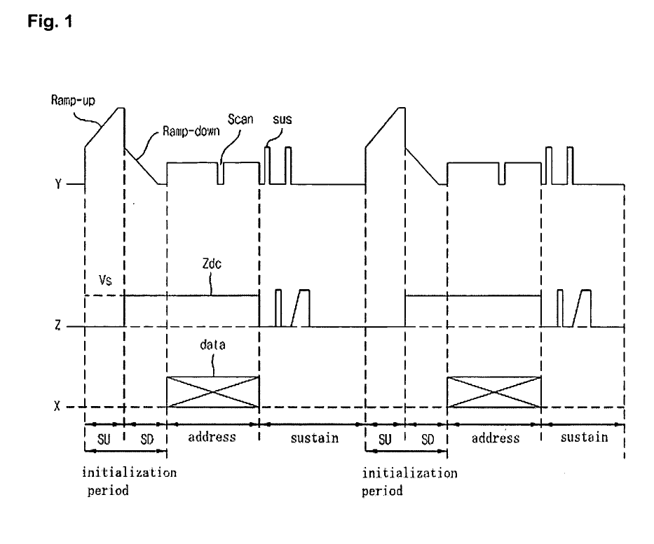

### DETAILED DESCRIPTION OF PREFERRED EMBODIMENTS

Preferred embodiments of the present invention will be described in a more detailed manner with reference to the drawings.

Hereinafter, detailed embodiments of the present invention will be described with reference to the appended drawings.

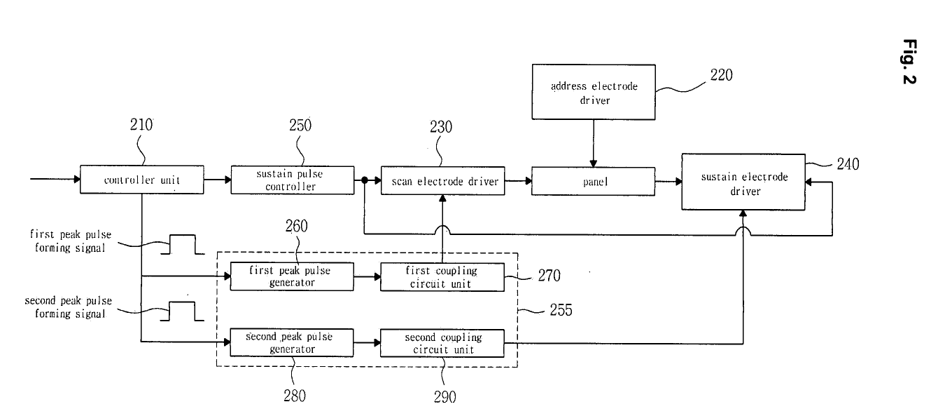

FIG. 2 is a block diagram of a plasma display apparatus according to the present invention. Referring to FIG. 2, the plasma display apparatus according to the present invention includes a controller unit 210, an address electrode driver 220, a scan electrode driver 230, a sustain electrode driver 240, a sustain pulse controller 250, and a peak pulse applying unit 255.

<Controller Unit>

The controller unit 210 controls the number of subfields corresponding to image data and the number of sustain pulses assigned to each subfield, outputs a Y timing signal and a Z timing signal for applying corresponding sustain pulses to each subfield, and outputs a first peak pulse-forming signal and a second peak pulse-forming signal respectively in synchronization with the Y timing signal and the Z timing signal.

<Address Electrode Driver>

The address electrode driver 220 applies a data pulse to address electrodes according to an X timing signal.

<Scan Electrode Driver>

The scan electrode driver 230 applies a sustain pulse to scan electrodes according to the Y timing signal.

<Sustain Electrode Driver>

The sustain electrode driver 240 applies a sustain pulse to sustain electrodes according to the Z timing signal.

<Sustain Pulse Controller>

The sustain pulse controller 250 controls the scan electrode driver 230 and the sustain electrode driver 240, according to the number of sustain pulses assigned to each subfield by the controller unit 210, the Y timing signal, and the Z timing signal.

<Peak Pulse Applying Unit>

The peak pulse applying unit 255 generates a peak pulse and causes the peak pulse to overlap a sustain pulse when the sustain pulse is applied alternately to the scan electrodes and the sustain electrodes. The peak pulse applying unit 255 includes a first peak pulse generator 260, a first coupling circuit unit 270, a second peak pulse generator 280, and a second coupling circuit unit 290.

The first peak pulse generator 260 receives the first peak pulse-forming signal from the controller unit 210 and outputs a peak pulse. The first peak pulse generator 260 includes a differential circuit, and receives a first peak pulse-forming signal with a rectangular waveform and outputs a trigger pulse through the differential circuit. That is, the first peak pulse generator 260 outputs a positive peak pulse with a trigger pulse waveform when the rectangular waveform rises, and outputs a negative peak pulse with a trigger pulse waveform when the rectangular waveform falls.

The first coupling circuit unit 270 removes the negative peak pulse output from the first peak pulse generator 260 and causes the positive peak pulse to overlap the sustain pulse which is applied to the scan electrodes. Here, the first coupling circuit unit 270 causes the positive peak pulse to overlap the sustain pulse when the corresponding sustain voltage is applied to the scan electrodes.

The second peak pulse generator 280 receives the second peak pulse-forming signal from the controller unit 210 and outputs a peak pulse. The second peak pulse generator 280 includes a differential circuit, and receives a second peak pulse-forming signal with a rectangular waveform and outputs a trigger pulse through the differential circuit. That is, the second peak pulse generator 280 outputs a positive peak pulse with a trigger pulse waveform when the rectangular waveform rises, and outputs a negative peak pulse with a trigger pulse waveform when the rectangular waveform falls.

The second coupling circuit unit 290 removes the negative peak pulse output from the second peak pulse generator 280 and causes the positive peak pulse to overlap the sustain pulse which is applied to the sustain electrodes. Here, the second coupling circuit unit 290 causes the positive peak pulse to overlap the sustain pulse when the corresponding sustain voltage is applied to the sustain electrodes.

### First Embodiment

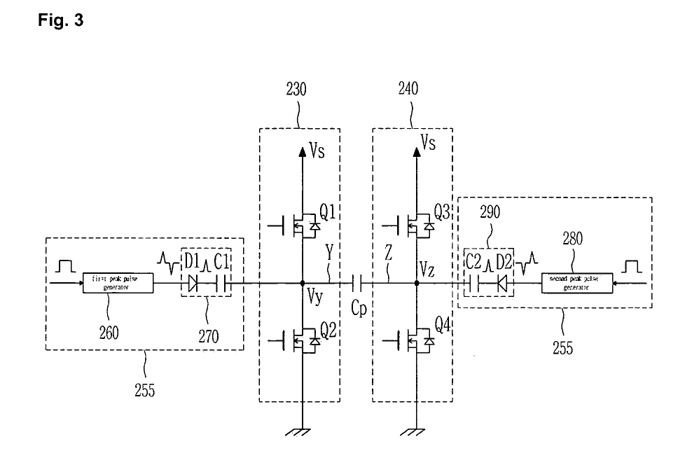

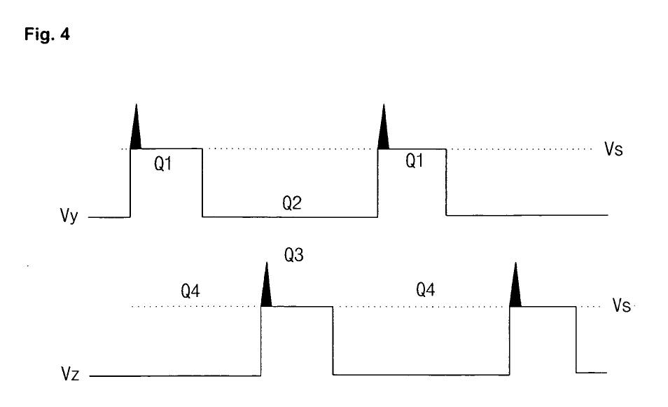

FIG. 3 shows a circuit configuration composed of a first peak pulse generator, a second peak pulse generator, a first coupling circuit unit, a second coupling circuit unit, and electrode drivers, which is included in the plasma display apparatus according to the present invention, according to a first embodiment of the present invention. FIG. 4 is a first embodiment of a sustain pulse waveform according to the present invention.

As shown in FIG. 3, a first peak pulse generator 260 which receives a first peak pulse-forming signal with a rectangular waveform from a controller unit 210, outputs a positive peak pulse with a trigger pulse waveform and a negative peak pulse with a trigger pulse waveform.

The first coupling circuit unit 270 includes a first diode D1 and a first capacitor C1. The anode terminal of the first diode D1 is connected to the first peak pulse generator 260 and the cathode terminal of the first diode D1 is connected to one end of the first capacitor C1. Also, the other end of the first capacitor C1 is connected to a scan electrode Y.

Accordingly, the positive peak pulse output from the first peak pulse generator 260 is applied to the scan electrode Y via the first diode D1 and the first capacitor C1 of the first coupling circuit unit 270. Also, the negative peak pulse output from the first peak pulse generator 260 is blocked by the first diode D1 of the first coupling unit 270.

The peak pulse formed through the first coupling circuit unit 270 overlaps a sustain voltage Vₛ which is applied to a panel capacitor Cₚ when a first switch Q1 of the scan electrode driver 230 is turned on.

The first peak pulse generator 260 outputs the positive peak pulse when the scan electrode driver 230 applies the sustain voltage Vₛ to the scan electrode Y. Accordingly, as shown in FIG. 4, since the positive peak pulse formed through the first coupling circuit unit 270 overlaps the sustain voltage Vₛ when the sustain voltage Vₛ is applied to the scan electrode Y, the voltage V_{y} of the scan electrode Y appears as the overlapped waveform of the sustain pulse Vₛ and the peak pulse.

That is, when the first switch Q1 of the scan electrode driver 230 applies the sustain voltage Vₛ to the scan electrode Y, the first peak pulse generator 260 applies the positive peak pulse to the scan electrode Y through the first coupling circuit unit 270. Accordingly, the voltage V_{y} of the scan electrode Y appears as the overlapped waveform of the sustain pulse Vₛ and the peak pulse.

The second peak pulse generator 280 and the second coupling circuit unit 290 operate in the similar manner to the first peak pulse generator 260 and the first coupling circuit unit 270.

That is, the second coupling circuit unit 290 includes a second diode D2 and a second capacitor C2. A positive peak pulse output from the second peak pulse generator 280 is applied to a sustain electrode Z via the second coupling circuit unit 290. Also, a negative peak pulse output from the second peak pulse generator 280 is blocked by the second diode D2 of the second coupling circuit unit 290.

A peak pulse formed through the second coupling circuit unit 290 overlaps a sustain voltage Vₛ which is applied to the sustain electrode Z when a third switch Q3 of the sustain electrode driver 240 is turned on.

The second peak pulse generator 280 outputs the positive peak pulse when the sustain electrode driver 240 applies the sustain pulse Vₛ to the sustain electrode Z. Accordingly, as shown in FIG. 4, since the positive peak pulse formed through the second coupling circuit unit 290 overlaps the sustain voltage Vₛ when the sustain voltage Vₛ is applied to the sustain electrode Z, the voltage V_{z} of the sustain electrode Z appears as the overlapped waveform of the sustain pulse Vₛ and the peak pulse.

That is, when the third switch Q3 of the sustain electrode driver 240 applies the sustain voltage Vₛ to the sustain electrode Z, the second peak pulse generator 280 applies the positive peak pulse to the sustain electrode Z through the second coupling circuit unit 290. Accordingly, the voltage V_{z} of the sustain electrode Z appears as the overlapped waveform of the sustain pulse Vₛ and the peak pulse.

As shown in FIG. 3, since the scan electrode driver 230 and the sustain electrode driver 240 have no energy recovery circuit, each of the voltages V_{y} and V_{z} of the scan electrode Y and the sustain electrode Z appears as the overlapped waveform of the sustain pulse Vₛ of a square wave and the peak pulse.

### Second Embodiment

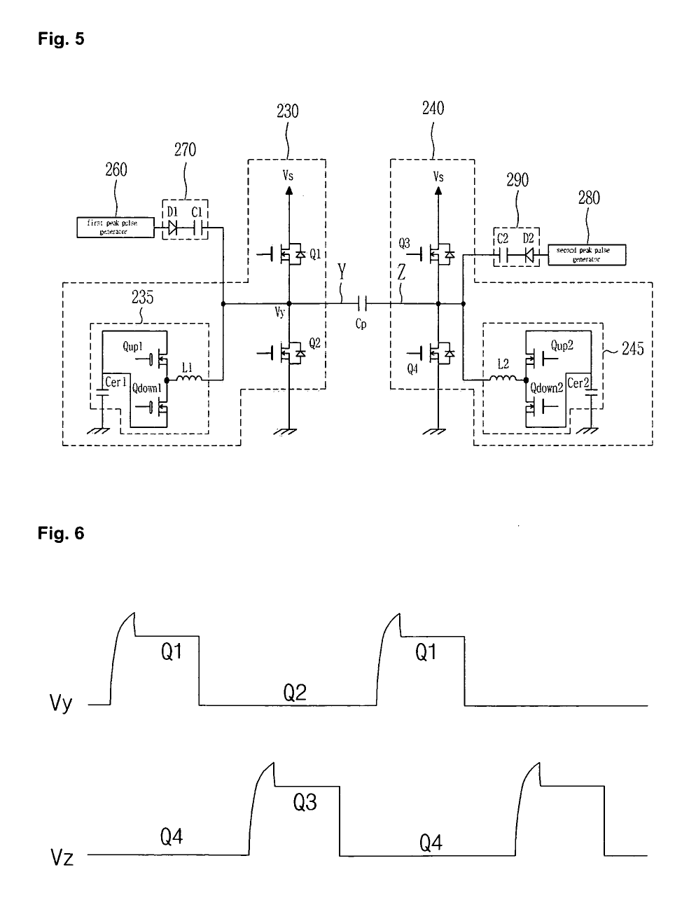

FIG. 5 shows a circuit configuration composed of a first peak pulse generator, a second peak pulse generator, a first coupling circuit unit, a second coupling circuit unit, and electrode drivers, which is included in the plasma display apparatus according to the present invention, according to a second embodiment of the present invention. FIG. 6 is a second embodiment of a sustain pulse waveform according to the present invention.

In the first embodiment shown in FIG. 3, the scan electrode driver 230 and the sustain electrode driver 240 include no energy recovery circuit, while in the second embodiment shown in FIG. 5, the scan electrode driver 230 and the sustain electrode driver 240 respectively include a first energy recovery circuit 235 and a second energy recovery circuit 245.

Accordingly, the first peak pulse generator 260, the first coupling circuit unit 270, the second peak pulse generator 280, and the second coupling circuit unit 290 apply a peak pulse to a scan electrode Y or a sustain electrode Z when a sustain voltage Vₛ is applied after energy is supplied from a first energy supply/recovery capacitor Cₑᵣ₁ or a second energy supply/recovery capacitor Cₑᵣ₂.

As such, if the peak pulse is applied, as shown in FIG. 6, each of the voltages V_{y} and V_{z} of the scan electrode Y or the sustain electrode Z appears as the overlapped waveform of the sustain pulse Vₛ and the peak pulse.

According to the plasma display apparatus of the present invention, a strong discharge is once generated by applying a peak pulse and another discharge is generated by applying a sustain pulse. That is, since a strong discharge is generated by a peak pulse while a discharge is discharged by a sustain pulse, brightness and contrast increase.

Therefore, the plasma display apparatus according to the present invention has advantages of enhancing brightness and contrast, minimizing power consumption and the amount of heat generation, and ensuring the reliability and stable operation of the plasma display apparatus, without increasing the number of sustain pulses.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel including a scan electrode and a sustain electrode;
a scan electrode driver applying a first sustain pulse to the scan electrode;
a sustain electrode driver applying a second sustain pulse to the sustain electrode alternately with the first sustain pulse; and
a peak pulse applying unit causing a peak pulse to overlap the first sustain pulse and the second sustain pulse when the first sustain pulse and the second sustain pulse are respectively applied alternately to the scan electrode and the sustain electrode.

2. The plasma display apparatus of claim 1, wherein the peak pulse applying unit causes the peak pulse to overlap the first sustain pulse and the second sustain pulse when sustain voltages respectively forming the first sustain pulse and the second sustain pulse are respectively applied to the scan electrode and the sustain electrode.

3. The plasma display apparatus of claim 1, wherein the peak pulse applying unit converts an incoming rectangular wave into the peak pulse, the peak pulse having a trigger pulse waveform, and causes the peak pulse to overlap the first sustain pulse and the second sustain pulse.

4. The plasma display apparatus of claim 1, wherein the scan electrode driver includes a first energy recovery circuit, and
the peak pulse applying unit causes the peak pulse to overlap the first sustain pulse when a sustain voltage forming the first sustain pulse is applied after energy is supplied by the first energy recovery circuit.

5. The plasma display apparatus of claim 1, wherein the sustain electrode driver includes a second energy recovery circuit, and the peak pulse applying unit causes the peak pulse to overlap the second sustain pulse when a sustain voltage which constitutes the second sustain pulse is applied after energy is supplied by the second energy recovery circuit.

6. The plasma display apparatus of claim 1, wherein the peak pulse applying unit comprises:
a first peak pulse generator for outputting the peak pulse to overlap the first sustain pulse;
a first coupling circuit unit for causing the peak pulse output from the first peak pulse generator to overlap the first sustain pulse;
a second peak pulse generator for outputting a peak pulse to overlap the second sustain pulse; and
a second coupling circuit unit for causing the peak pulse output from the second peak pulse generator to overlap the second sustain pulse.

7. The plasma display apparatus of claim 6, wherein the first peak pulse generator includes a differential circuit and converts a rectangular waveform received through the differential circuit into a positive peak pulse and a negative peak pulse, each having trigger pulse waveforms, and the first coupling circuit unit causes the positive peak pulse to overlap the first sustain pulse.

8. The plasma display apparatus of claim 6, wherein the second peak pulse generator includes a differential circuit and converts a rectangular waveform received through the differential circuit into a positive peak pulse and a negative peak pulse, each having trigger pulse waveforms, and the second coupling circuit unit causes the positive peak pulse to overlap the second sustain pulse.

9. The plasma display apparatus of claim 7, wherein the first peak pulse generator generates the positive peak pulse with the trigger pulse waveform when the rectangular waveform rises and generates the negative peak pulse when the rectangular waveform falls.

10. The plasma display apparatus of claim 8, wherein the second peak pulse generator generates the positive peak pulse with the trigger pulse waveform when the rectangular waveform rises and generates the negative peak pulse when the rectangular waveform falls.

11. The plasma display apparatus of claim 7, wherein the first coupling circuit unit includes a first diode having an anode terminal connected to the first peak pulse generator, and a first capacitor having one end connected to a cathode terminal of the first diode and the other end connected to the scan electrode.

12. The plasma display apparatus of claim 8, wherein the second coupling circuit unit includes a second diode having an anode terminal connected to the second peak pulse generator, and a second capacitor having one end connected to a cathode terminal of the second diode and the other end connected to the sustain electrode.

13. The plasma display apparatus of claim 6, wherein the scan electrode driver includes a first energy recovery circuit, and
the peak pulse applying unit causes the peak pulse to overlap the first sustain pulse when a sustain voltage which constituts the first sustain pulse is applied after energy is supplied by the first energy recovery circuit.

14. The plasma display apparatus of claim 6, wherein the sustain electrode driver includes a second energy recovery circuit, and
the peak pulse applying unit causes the peak pulse to overlap the second sustain pulse when a sustain voltage which constituts the second sustain pulse is applied after energy is supplied by the second energy recovery circuit.

15. A plasma display apparatus comprising:
a plasma display panel including a scan electrode and a sustain electrode;
a scan electrode driver for applying a first sustain pulse to the scan electrode;
a sustain electrode driver for applying a second sustain pulse to the sustain electrode alternately with the first sustain pulse; and
a peak pulse generator for causing a peak pulse to overlap sustain pulses when the sustain pulses are respectively applied to the scan electrode and the sustain electrode,
wherein the peak pulse generator comprises:
a first peak pulse generator for outputting a peak pulse to overlap a sustain pulse applied to the scan electrode; a first coupling circuit unit for causing the peak pulse output from the first peak pulse generator to overlap the sustain pulse applied to the scan electrode; a second peak pulse generator for outputting a peak pulse to overlap a sustain pulse applied to the sustain electrode; and a second coupling circuit unit for causing the peak pulse output from the second peak pulse generator to overlap the sustain pulse applied to the sustain electrode.

16. A driving method of a plasma display apparatus, the plasma display apparatus in which a discharge is maintained by a first sustain pulse and a second sustain pulse applied alternately to a scan electrode and a sustain electrode, the method comprising:
causing a first peak pulse to overlap the first sustain pulse when the first sustain pulse is applied to the scan electrode; and
causing a second peak pulse to overlap the second sustain pulse when the second sustain pulse is applied to the sustain electrode.

17. The driving method of claim 16, wherein the first peak pulse overlaps the first sustain pulse when a sustain voltage forming the first sustain pulse is applied to the scan electrode.

18. The driving method of claim 16, wherein the second peak pulse overlaps the second sustain pulse when a sustain voltage which constitues the second sustain pulse is applied to the sustain electrode.

19. The driving method of claim 16, wherein the first peak pulse overlaps the first sustain pulse when a sustain voltage is applied after energy for forming the first sustain pulse is supplied to a plasma display panel.

20. The driving method of claim 16, wherein the second peak pulse overlaps the second sustain pulse when a sustain voltage is applied after energy for forming the second pulse is supplied to a plasma display panel.
